(19) United States
(12) Patent Application Publication
(10) Pub. No.: US 2019/0065007 A1
(43) Pub. Date: Feb. 28, 2019

(54) USER INTERFACE COMPRISING A PLURALITY OF DISPLAY UNITS, AND METHOD FOR POSITIONING CONTENTS ON A PLURALITY OF DISPLAY UNITS

(71) Applicant: SIEMENS AKTIENGESELLSCHAFT, München (DE)

(72) Inventors: CHRISTIAN BUTTER, MÜNCHEN (DE); ECKHARD SEIBERT, HAGENBACH (DE); SILVIO WOLF, HAAR (DE)

(21) Appl. No.: 16/078,036

(22) PCT Filed: Feb. 14, 2017
(86) PCT No.: PCT/EP2017/053194

§ 371 Date: Aug. 21, 2018

(30) Foreign Application Priority Data
Feb. 22, 2016 (DE) 10 2016 202 694.1

(51) Int. Cl. G06F 3/0481; G06F 3/14; G06F 3/0486; G06F 3/0488; G06F 3/0484

(52) U.S. Cl. CPC G06F 3/0481; G06F 3/1423; G06F 3/04842; G06F 3/0488; G06F 3/0486

(57) ABSTRACT

Provided is a user interface allows a user to select a window, which is to be placed somewhere, on a graphic user surface by means of a first user action, and select, by means of a third user action, a target display unit, e.g. a screen or a large projection screen, on which the window to be placed is then displayed. In one variant, the third user action allows each display unit to be selected in a diagram.

### CROSS-REFERENCE TO RELATED APPLICATIONS

This application claims priority to PCT Application No. PCT/EP2017/053194, having a filing date of Feb. 14, 2017, based on German Application No. 10 2016 202 694.1, having a filing date of Feb. 22, 2016, the entire contents both of which are hereby incorporated by reference.

### FIELD OF TECHNOLOGY

The following relates to a user interface having a plurality of display units, and to a method for positioning content in working environments having a plurality of display units.

Working environments having a plurality of display units, including for example monitors or big screens, depict a wide range of content and are often used in control rooms. The display units in this case form, in their specific arrangement, a multi-monitor working environment. They may be any desired screens, big screens or projectors that receive and output image information from a computer.

### BACKGROUND

It is known to position content on the various display units by way of a computer mouse. To this end, a user moves an item of content, possibly even over a plurality of monitors, to the desired position. By way of example, the Microsoft Windows operating system allows the desktop to be expanded over a plurality of monitors and windows to be moved over the monitor boundaries.

The following is intended to create a user interface having a plurality of display units and a method for positioning content on a plurality of display units, which interface and method provide an alternative to the prior art.

### SUMMARY

An aspect relates to a user interface having a plurality of display units. The user interface has an operator display unit and at least one processor, which is programmed to output a graphical user interface on the operator display unit, wherein the graphical user interface contains a number of windows. The user interface furthermore has at least one further display unit, which is connected to the processor, and is characterized in that the processor is programmed to select a window to be distributed from the number of windows depending on a first user action on the graphical user interface, select a display unit from the further display units depending on a second user action on the graphical user interface, and output the selected window to be distributed on the selected display unit.

In the method for positioning content on a plurality of display units, at least one processor displays a graphical user interface on an operator display unit, which graphical user interface depicts a number of windows that are able to be positioned on at least one further display unit. The processor selects a window to be distributed from the number of windows on the graphical user interface on the basis of a first user action. It then selects a display unit from the further display units on the basis of a second user action on the graphical user interface. It then outputs the selected window to be distributed on the selected display unit.

This may involve a single processor. The processor may for example execute an operating system that provides the graphical user interface. The processor, which is for example a microprocessor of a computer, may however be supported by further processors to any desired extent in the execution of the method. For example, the processor is part of a single-chip system, which contains at least one graphics processor. Likewise, the computer system in which the processor works may have one or more separate graphics cards. The graphics processors or graphics cards may in this case assume tasks in the outputting of the graphical user interface and controlling the display units that relieve the processor. The same also applies to the embodiments and developments of the invention.

The advantages mentioned below do not necessarily have to be achieved through the subject matter of the independent patent claims. Rather, they may also be advantages that are achieved only through individual embodiments, variants or developments.

The user interface and the method allow a user to select the window to be distributed on the graphical user interface by way of the first user action, and to select a target display unit, for example a monitor or a big screen, on which the window to be distributed is intended to be depicted, by way of the second user action.

The user interface and the method thus offer a user the advantage of being able to position, from the operator display unit, into any desired display units of a multi-monitor working environment, including any big screens that may be present. In this case, the user no longer has to devote his attention to the moving process, for example by keeping a mouse button pressed over a long path in order to move a window over several monitors, but is able to concentrate entirely on the positioning of the window on the display units of the multi-monitor working environment. The positioning is in this case effected accurately and is intuitive to operate. Positioning is also possible when the target display unit is not in the preferred field of view of the user or completely outside his field of vision. The positioning is ergonomic as the user is able to work on the operator display unit in his preferred field of view.

Furthermore, the user interface and the method for the first time allow such positioning by touch input, even though the target for the positioning lies outside the operator display unit. In the case of touchscreens, there is no provision for an input device such as a mouse for moving the content. It is therefore not possible to work or position beyond the physical boundaries of the touchscreen using touch gestures.

However, since all of the user actions take place on the operator display unit, the user interface and the method also allow positioning by touch input. They are therefore suitable for various input methods such as touch or mouse operation, and independent of the specific input medium, as a result of which other input methods such as for example keypad inputs are also able to be used.

According to one embodiment, the at least one processor outputs a schematic depiction of the spatial arrangement of the further display units on the graphical user interface, wherein each of the further display units in the schematic depiction is able to be selected by way of the second user action.

The schematic depiction is a scaled-down depiction or a schematic portrayal of a multi-monitor working environment that is formed from the display units of the user interface. The schematic depiction in this case forms an operating element of the graphical user interface, which operating element is able to be actuated for example by a mouse or by touch.

According to one variant of this embodiment, the first user action forms the start and the second user action forms the end of a drag-and-drop operation, which is able to be performed in particular with mouse operation, or which is able to be performed in particular by touch, wherein the operator display unit is a touchscreen. As an alternative, the second user action forms a drag-and-drop operation, which is able to be executed only after the first user action has concluded.

This variant makes it possible to drag the item of content to be distributed by drag and drop onto one of the display units in the schematic depiction.

According to one development, the processor allows successive selection of a plurality of the further display units during the second user action, wherein the respectively last selected display unit is the selected display unit. The processor outputs visual feedback on the respectively currently selected display unit, which temporarily highlights said display unit, during the second user action.

By way of example, in the context of the second user action, in the schematic depiction on the operator display unit (which is configured as a touchscreen in this case), the user touches one of the further display units. While his finger is still touching the touchscreen, the currently selected display unit is visually highlighted, for example by a colored marking or a change in brightness or contrast. This visual feedback is effected both in the schematic depiction and on the actual selected display unit. On the basis of this visual feedback, the user is able to move his fingertip on the operator display unit, in the context of the second user action, until it comes to lie on another display unit in the schematic depiction. The visual feedback is then output on the newly selected display unit. In the same way, the user could also travel through the display units in the schematic depiction with a pressed mouse button. The final selection of the display unit results from the last selected display unit when the user releases the mouse button or lifts his finger from the operator display unit.

Furthermore, the window to be distributed may also be dragged onto the schematic depiction by way of a drag-and-drop operation, wherein in this case too both touch operation and mouse operation is able to be implemented. In this case, the visual feedback may be displayed successively before the end of the drag-and-drop operation, i.e. before the release. The visual feedback is effected here without a noteworthy time delay and follows the movement of the second user action. It supports collaborative working, since all of the users of the multi-monitor working environment follow the second user action and are able to comment on and support the selection. Furthermore, the visual feedback also allows the user himself to direct his view to the multi-monitor working environment, i.e. to the actual further display units, during the second user action.

According to one embodiment, at least one of the further display units has a graphical user interface that is divided into a plurality of display areas. In the context of the second user action, one of the display areas is able to be selected. The selected window to be distributed is output on the selected display area.

In combination with the schematic depiction explained above, the variant results here that the display areas are also identified in the schematic depiction. Furthermore, in combination with the visual feedback explained above, the variant results that the user sweeps over various display areas in the schematic depiction in the context of the second user action, wherein in each case visual feedback is output on the currently selected display area. Not all of the display units have to be divided into a plurality of display areas.

In one development, before the first user action, for each window of the number of windows, an operating element is displayed on the graphical user interface, wherein each of the operating elements is able to be chosen by way of the first user action.

According to one embodiment, the schematic depiction is displayed immediately after the first user action overlapping or adjacent to the chosen operating element.

In one development, a distribution mode is activated beforehand following detection of an initial user action, wherein the windows from the number of windows are identified visually as able to be distributed on the graphical user interface only in the distribution mode. In one variant, the abovementioned operating elements are displayed only in the distribution mode. In a further variant, the abovementioned schematic depiction is displayed only in the distribution mode.

The distribution mode enables visual highlighting and identification of the windows able to be distributed flexibly as able to be manipulated for the user. As a result, the windows able to be distributed in the multi-monitor working environment are illustrated extremely unambiguously and in a manner that does not additionally overload the complex graphical user interface with permanently visible operating elements. This is because the windows able to be distributed are visually highlighted only after activation of the distribution mode. The legibility of the graphical user interface in a standard mode is thus not restricted, as no additional operating elements or icons other than an operating element for the mode change have to be displayed there.

According to one embodiment, a switch is displayed on the graphical user interface, wherein the initial user action is detected when the switch is actuated.

In one development, the user interface has an electrical switch, which is arranged in the vicinity of the operator display unit. The processor is programmed to detect the initial user action on the basis of actuation of the switch.

According to one embodiment, the operator display unit is a touchscreen that is set up to detect the first user action and the second user action as touch inputs.

A computer program is recorded on the computer-readable data medium, which computer program executes the method when it is run in the processor. The computer program is run in the processor and executes the method there.

### BRIEF DESCRIPTION

Some of the embodiments will be described in detail, with references to the following Figures, wherein like designations denote like members, wherein:

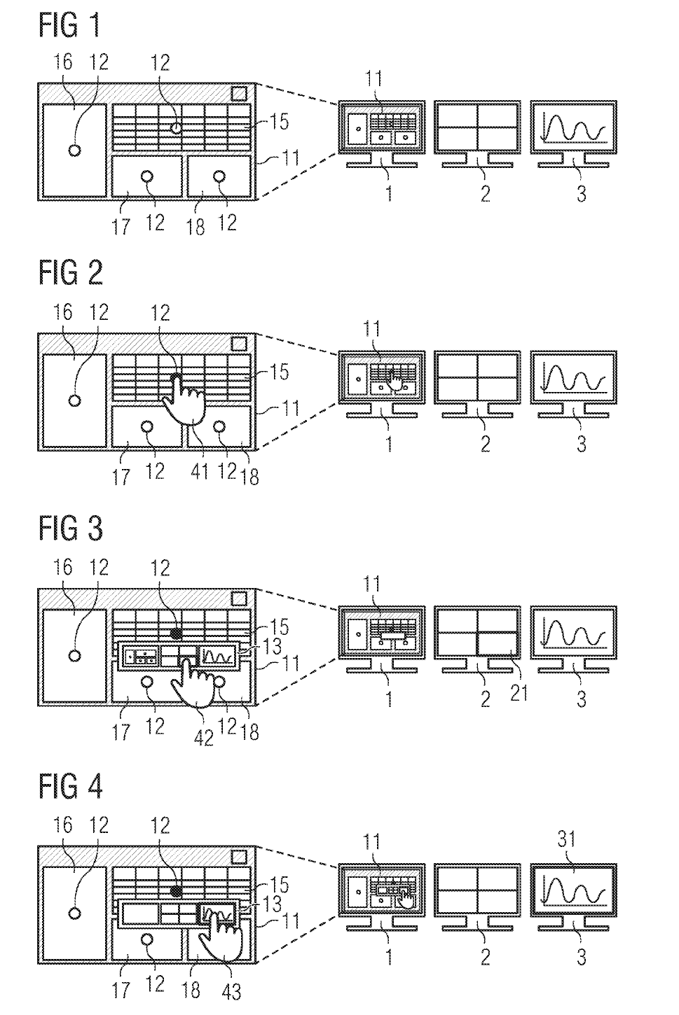

FIG. 1 shows an operator display unit having a graphical user interface and two further display units, and a magnified illustration of the graphical user interface;

FIG. 2 shows a first user action, which selects a window to be distributed on the graphical user interface;

FIG. 3 shows a second user action, which selects a partial area of a second display unit in a schematic depiction on the graphical user interface;

FIG. 4 shows a third user action, which selects a third display unit;

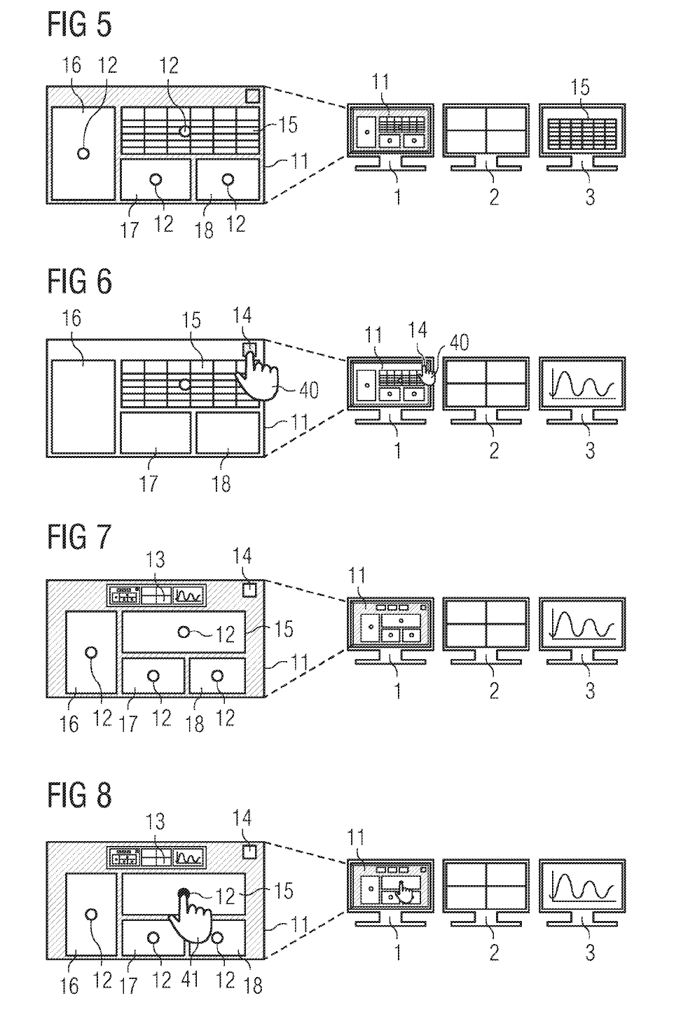

FIG. 5 shows an illustration of the window to be distributed on the third display unit;

FIG. 6 shows a user interface in a standard mode;

FIG. 7 shows the user interface from FIG. 6 after activation of a distribution mode;

FIG. 8 shows selection of a window to be distributed by way of a first user action;

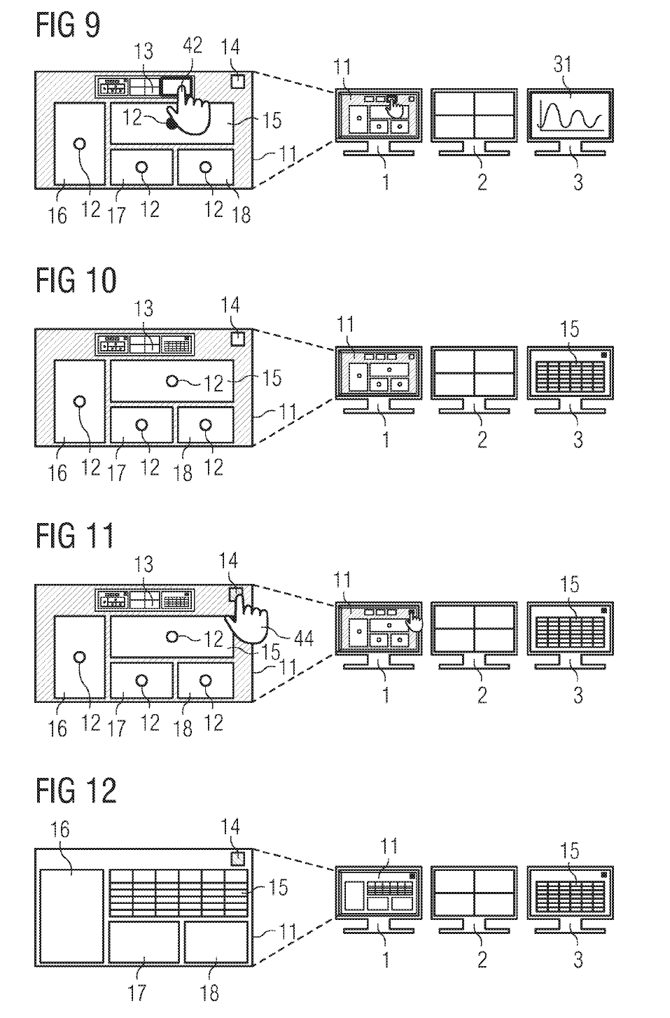

FIG. 9 shows selection of a third display unit by way of a second user action;

FIG. 10 shows an illustration of the window to be distributed on the third display unit;

FIG. 11 shows a final user action for deactivating the distribution mode on the graphical user interface;

FIG. 12 shows the user interface after deactivation of the distribution mode; and

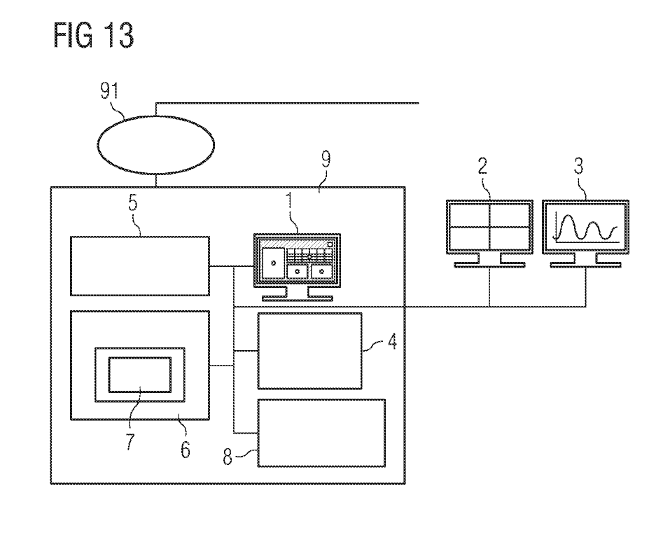

FIG. 13 shows an architecture of a user interface having a plurality of display units.

### DETAILED DESCRIPTION

FIG. 1 shows an operator display unit 1 on which a graphical user interface 11 is output, and a second display unit 2 and a third display unit 3. The display units are part of a user interface whose architecture is configured by way of example in accordance with FIG. 13, which is explained further below. As an alternative to FIG. 1, the user interface may also comprise only the operator display unit 1 and the second display unit 2. It is likewise possible for the user interface, in addition to the operator display unit 1, the second display unit 2 and the third display unit 3, to comprise further display units.

Of course, the user interface may have further display units that are controlled and selected in the same way as is described in the exemplary embodiments. In principle, each of the display units may also have a plurality of partial areas, for example quadrants, which on their part are able to be treated and selected as separate display units. Conversely, the second display unit 2 and the third display unit 3 may also be just partial areas of a big screen. These generalizations and variants apply with respect to all of the exemplary embodiments.

FIG. 1 illustrates the graphical user interface 11 on the left-hand side in magnified form again for the sake of illustration. It contains windows 15, 16, 17, 18, which in principle are also able to be output on the second display unit 2 and the third display unit 3. The graphical user interface 11 provides an operating element 12 for each window 15, 16, 17, 18, by way of which operating element the respective window is able to be selected for distribution onto the second display unit 2 or the third display unit 3.

The operator display unit 1, the second display unit 2 and the third display unit 3, and possibly further display units, form a multi-monitor working environment in their spatial arrangement. The second display unit 2 is in this case by way of example divided into four quadrants, which each form a display area for one of the windows 15, 16, 17, 18 on the operator display unit 1, whereas each of these windows would be depicted full-screen on the third display unit 3. Of course, such a division or a full-screen depiction may be selected for each of the display units 2, 3 depending on requirements.

FIG. 2 shows the user interface from FIG. 1, wherein a user now touches the operating element 12 for the window 15 by way of a first user action 41, as the window 15 is intended to be distributed onto one of the further display units 2, 3. Then, as shown in FIG. 3, a schematic depiction 13 of all of the display units, i.e. the entire multi-monitor working environment, is output below the chosen operating element 12 on the graphical user interface 11. In the schematic depiction 13, the operator display unit 1, the second display unit 2 and the third display unit 3 are arranged schematically according to their actual spatial arrangement. In one variant, in this case the depiction of the operator display unit 1 itself may be dispensed with.

Within the schematic depiction 13, the user now selects, by way of a second user action 42, the lower right-hand quadrant of the second display unit 2 as display area for the window 15 to be distributed. Visual feedback 21 is then output on the second display unit 2, which feedback for example changes a background color, a contrast, a brightness or similar image parameters of the lower right-hand quadrant or displays a marking.

All of the user actions may be executed as touch inputs if the operator display unit 1 is a touchscreen. By way of example, the operator display unit 1 could be part of a tablet computer. However, the user actions may also be performed by mouse, keypad or any other suitable input device that allows choosing of windows of the graphical user interface 11. These generalizations and variants apply for all of the exemplary embodiments.

FIG. 4 shows the case where the user selects a third display unit 3 by way of a third user action 43, on which third display unit visual feedback 31 is then output. The user is therefore able to successively select a plurality of display units or display areas in the schematic depiction 13 until the visual notification is output on the display unit that corresponds to his wishes.

The difference between a preliminary selection, as in FIG. 3, and a final selection, as in FIG. 4, may be implemented in a great many ways. By way of example, FIG. 3 could correspond to a simple mouse-over or to just a light press on the touchscreen with a fingertip. Such a second user action 42 may be recognized by the user interface and used to output the visual feedback 21. A final selection, as by way of the third user action 43 in FIG. 4, is then detected for example by a mouse click being performed or a touch at a greater pressure. Furthermore, the second user action 42 may be implemented as a single mouse click and the third user action 43 as a double mouse click. One further possibility is that of combining the second user action 42 and the third user action 43 in the context of a sweeping movement. By way of example, the user presses down on a mouse button with the second user action 42 and then moves the mouse pointer, with the button pressed, over various display areas or display units until the visual feedback 31 is output on the desired display unit 3. By releasing the mouse button, the user then confirms the selection that is made. In the case of touching a touchscreen as well, this operating method may be selected, wherein that display unit that the user touches is selected before he takes his finger off the touchscreen. To confirm the final selection, a separate operating element may also be provided. Furthermore, the operating element 12 of the element 15 to be distributed may also be dragged onto the desired display area or display unit in the context of a drag-and-drop operation, wherein in this case too, in the context of the drag-and-drop movement, which may be executed optionally by mouse button or by touch, various display units or display areas may be swept through, wherein in each case visual feedback is output on the display area or display unit being swept through. The display area or display unit that is finally selected results from the end position of the drag-and-drop operation.

In FIG. 4, the final selection of the user is the third display unit 3 selected by way of the third user action 43. FIG. 5 accordingly shows the outputting of the window 15 to be distributed on the third display unit 3.

FIGS. 6 to 12 show a further exemplary embodiment. FIG. 6 again shows a multi-monitor working environment, which is formed for example from an operator display unit 1, a second display unit 2 and a third display unit 3. A graphical user interface 11, which is depicted on the operator display unit 1, is again also illustrated in magnified form in FIG. 6 on the left-hand side for the sake of illustration. The graphical user interface 11 is in a standard mode in which, with respect to the distribution of windows 15, 16, 17, 18 of the graphical user interface 11 onto the further display units 2, 3, only a single graphical element, in this case a switch 14, is depicted. This has the advantage that the user interface 11 is not overloaded by numerous graphical elements for the distribution functions in the standard mode. A user now activates the switch 14 by way of an initial user action 40, as a result of which a distribution mode is activated.

FIG. 7 shows the graphical user interface 11 after the distribution mode has been activated. In order to visually highlight the distribution mode for the user, the user interface 11 is depicted in inverted form. By way of the inverted depiction, the distribution mode visually highlights the windows 15, 16, 17, 18 and informs the user that they are able to be distributed onto the further display units 2, 3. To this end, in the distribution mode, an operating element 12 is depicted on the graphical user interface 11 for each of the windows 15, 16, 17, 18, by way of which operating element the respective windows are able to be selected by the user. Furthermore, in the distribution mode, a schematic depiction 13 is overlaid, as was already explained in the context of FIGS. 3 and 4. The schematic depiction is now arranged at the upper edge of the graphical user interface 11.

FIG. 8 shows a first user action 41, by way of which the user activates the operating element 12 of the window 15 to be distributed. The window 15 is thereby selected for distribution onto one of the display units 2 or 3.

The user then touches, as shown in FIG. 9, the symbol of the third display unit 3 in the schematic depiction 13 by way of a second user action 42. In this case, visual feedback 31 is output on the selected third display unit 3.

The depiction on the third display unit 3 is then replaced by the window 15 to be distributed, which the user had selected by way of the first user action 41. This is shown in FIG. 10.

The user then ends the distribution mode by way of a final user action 44 by deactivating the switch 14 for the distribution mode, as shown in FIG. 11. As a result, the graphical user interface 11 is reset to the standard mode, as shown in FIG. 12.

The switch 14 does not necessarily have to be an element of the graphical user interface 11. It may also be configured as a physical electrical switch and for example be formed by a special button on a keypad.

FIG. 13 shows a possible architecture of the user interface. A computer 9 contains a processor 5, which runs a computer program 7 that is has loaded in its working memory 6 from a secondary memory 8. The user inputs explained above are detected by way of an input device 4, which is optionally the touch-sensitive surface of a touchscreen, a computer mouse, a keypad or any other input device suitable for operating a graphical user interface. The graphical user interface is output on an operator display unit 1, which still belongs directly to the computer 9. A second display unit 2 and a third display unit 3 are likewise supplied with image information from the computer 9, but the display units may also be arranged at a greater distance. By way of example, the third display unit 3 could be a big screen in a control room.

It is possible in principle for the computer 9 to control the second display unit 2 and the third display unit 3 with image information directly by way of a graphics card. In this case, this is for example an expanded desktop whose various display units are managed and controlled by the graphics card.

Although the invention has been illustrated and described in greater detail with reference to the preferred exemplary embodiment, the invention is not limited to the examples disclosed, and further variations can be inferred by a person skilled in the art, without departing from the scope of protection of the invention.

For the sake of clarity, it is to be understood that the use of “a” or “an” throughout this application does not exclude a plurality, and “comprising” does not exclude other steps or elements.

1. A user interface having a plurality of display units: comprising:
an operator display unit and at least one processor, which is programmed to output a graphical user interface on the operator display unit, wherein the graphical user interface contains a plurality of window; and
at least one further display unit, which is connected to the at least one processor, wherein the as least one processor is programmed to:
select a window to be distributed from the plurality of windows depending on a first user action on the graphical user interface,
select a display unit from the at least one further display units depending on a second user action on the graphical user interface, and
output the selected window to be distributed on the selected display unit.

2. The user interface as claimed in claim 1, wherein the at least one processor is programmed to output a schematic depiction of a spatial arrangement of the further display units on the graphical user interface, therein each of the further display units in a schematic depiction is able to be selected by way of the second user action.

3. The user interface as claimed in claim 1, wherein the processor is programmed to
successively select a plurality of the further display units during the second user action, wherein the respectively last selected display unit is the selected display unit, and
output visual feedback on the respectively currently selected display unit, which temporarily highlights the display unit, during the second user action.

4. The user interface as claimed in claim 1,
wherein at least one of the further display units has a graphical user interface that is divided into a plurality of display areas,
wherein, in the context of the second user action, one of the display areas is able to be selected, and
wherein the selected window to be distributed is output on the selected display area.

5. The user interface as claimed in claim 1, wherein the at least one processor is programmed to:
output an operating element for each window of the plurality of windows on the graphical user interfaced, wherein each of the operating elements is able to be chosen by way of the first user action.

6. The user interface as claimed in claim 2, wherein the at least one processor is programmed to
output the schematic depiction immediately after the first user action, wherein the schematic depiction is arranged overlapping or adjacent to the chosen operating element.

7. The user interface as claimed in claim 5, wherein the at least one processor is programmed to;
activate a distribution mode by way of an initial user action, and
restrict the output of the operating elements to the distribution mode.

8. The user interface as claimed in claim 2, wherein the at least one processor is programmed to:
restrict the output of the schematic depiction to the distribution mode.

9. The user interface as claimed in claim 7, wherein the at least one processor is programmed to
output a switch on the graphical user interface, and
detect the initial user action when the switch is actuated.

10. The user interface as claimed in claim 7, further comprising:
an electrical switch, which is arranged in a vicinity of the operator display unit,
wherein the at least one processor is programmed to detect the initial user action on a basis of actuation of the switch.

11. The user interface as claimed claim 1,
wherein the operator display unit is a touchscreen that is set up to detect the first user action and the second user action as touch inputs.

12. A method for positioning content on a plurality of display units, the method comprising:
displaying, by at least one processor, a graphical user interface on an operator display unit, wherein the graphical user interface depicts a plurality of windows that are able to be positioned on at least one further display unit,
selecting, by the at least one processor, a window to be distributed from the plurality of windows on the graphical user interface on the basis of a first user action,
selecting, by the at least one processor, a display unit from the further display units on the graphical user interface on a basis of a second user action, and
outputting by the at least one processor, the selected window to be distributed on the selected display unit.

13. The method as claimed in claim 12,
wherein the at least one processor outputs a schematic depiction of the spatial arrangement of the further display units on the graphical user interface, wherein each of the further display units in the schematic depiction is able to be selected by way of the second user action.

14. The method as claimed in claim 13,
wherein the first user action forms a start and the second user action forms an end of a drag-and-drop operation, which is able to be performed with a mouse operation, or which is able to be performed by touch, wherein the operator display unit is a touchscreen, or
wherein the second user action is a drag-and-drop operation, which is able to be executed only after the first user action has concluded.

15. The method as claimed in claim 12,
wherein a plurality of the further display units are able to be selected successively during the second user action, wherein the respectively last selected display unit is the selected display unit, and
wherein visual feedback is output on the respectively currently selected display unit, which temporarily highlights the display unit, during the second user action.

16. The method as claimed in claim 12,
wherein at least one of the further display units has a graphical user interface that is divided into a plurality of display areas,
wherein, in a context of the second user action, one of the display areas is able to be selected, and
wherein the selected window to be distributed is output on the selected display area.

17. The method as claimed in claim 12,
wherein, before the first user action, for each window of the number of windows, an operating element is displayed on the graphical user interface, wherein the first user action chooses one of the operating elements.

18. The method as claimed in claim 13,
wherein the schematic depiction is displayed immediately after the first user action overlapping or adjacent to the chosen operating element.

19. The method as claimed in claim 12,
wherein a distribution mode is activated beforehand following detection of an initial user action, and
wherein the windows from the plurality of windows are identified visually as able to be distributed on the graphical user interface only in the distribution mode.

20. The method as claimed in claim 18,
wherein the chosen operating elements is displayed only in the distribution mode.

21. The method as claimed in claim 13,
wherein the schematic depiction is displayed on the graphical user interface only in the distribution mode.

22. The method as claimed in claim 19,
wherein a switch is displayed on the graphical user interface, wherein the initial user action actuates the switch.

23. A computer-readable data medium,
on which a computer program is recorded, which computer program executes the method as claimed in claim 12 when the computer program is run in the processor.

24. A computer program product, comprising a computer readable hardware storage device storing a computer readable program code, the computer readable program code comprising an algorithm that when executed by a computer processor of a computing system implements a method as claimed in claim 12.
